(19) United States
(12) Patent Application Publication
(10) Pub. No.: US 2014/0204380 A1
(43) Pub. Date: Jul. 24, 2014

(54) METHOD FOR DETECTING ALIGNMENT BETWEEN OPTICAL FIBERS AND LENSES OF OPTICAL CONNECTOR

(71) Applicant: HON HAI PRECISION INDUSTRY CO., LTD., NEW TAIPEI (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/014,388

(22) Filed: Aug. 30, 2013

(30) Foreign Application Priority Data
Jan. 23, 2013 (TW) 102102541

(51) Int. Cl. G01B 11/27

(52) U.S. Cl. CPC G01B 11/272
USPC 356/400

(57) ABSTRACT

In a method for determining alignment between an optical fiber and a converging or diverging lens, light is directed into an optical fiber of an optical connector with a lens element. The lens element has a front surface forming a lens and a back surface defining a recess, the optical fiber is inserted into the recess and points at the lens, to form a light spot on the front surface. An image of the front surface of the lens is captured and a coordinate system is established. Coordinate values of the center of the lens and of the light spot in the coordinate system are measured. The respective coordinate values of the center of the lens and of the center of the light spot are compared for matching or otherwise to determine correct alignment or otherwise.

### BACKGROUND

1. Technical Field

The present disclosure relates to optical connectors and, particularly, to a method for detecting if optical fibers are aligned with lenses in an optical connector.

2. Description of Related Art

Optical connectors include a lens element and a number of optical fibers. The lens element has lenses at one side and defines receiving recesses in another side. The optical fibers are inserted into the receiving recesses and, to increase light usage efficiency, each optical fiber should be aligned with one of the lenses. However, upon assembly, the optical fibers are hidden from view and correct alignment between the optical fiber and the lenses is difficult to detect.

Therefore, it is desirable to provide a method for detecting alignment between optical fibers and lenses of an optical connector that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an optical connector, according to an embodiment.

FIG. 2 is similar to FIG. 1, but viewed from another angle.

FIGS. 3-5 show how to detect misalignment for the optical connector of FIG. 1.

### DETAILED DESCRIPTION

Embodiments of the present disclosure will be described with reference to the drawings.

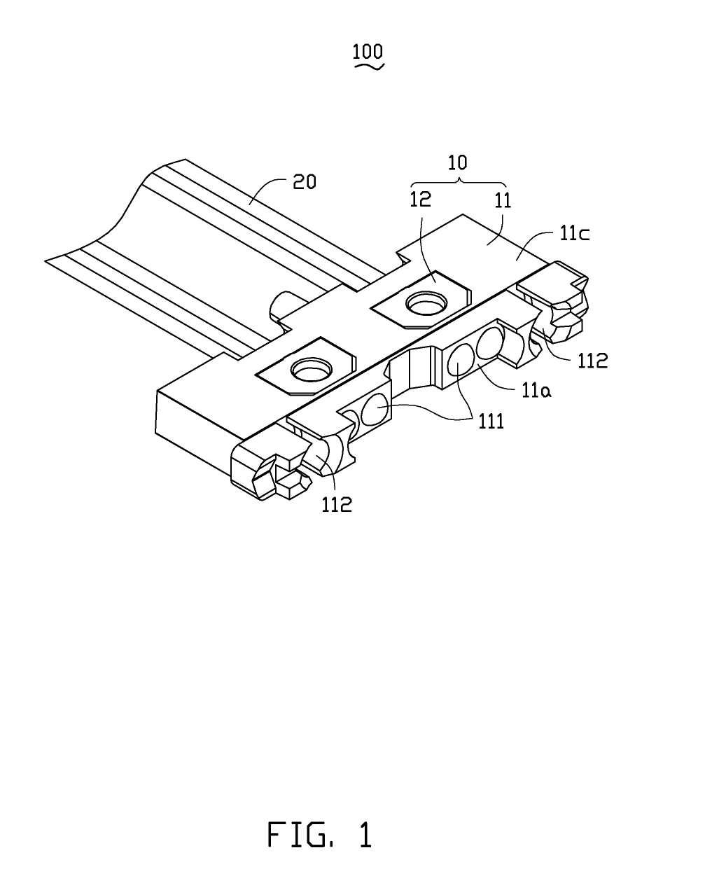

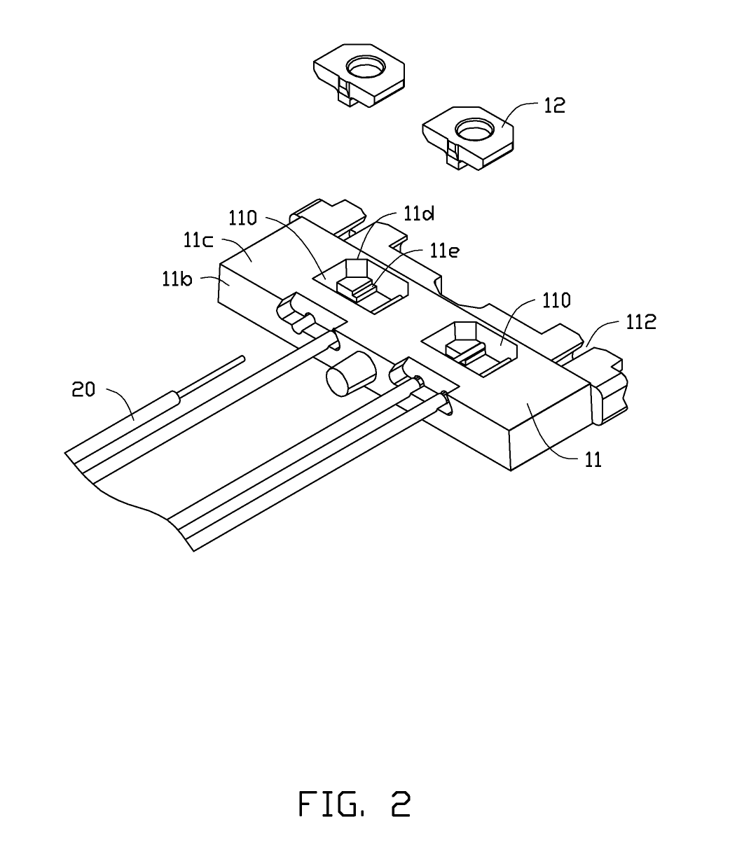

FIGS. 1-2 show an optical connector 100, according to an embodiment. The optical connector 100 includes a lens element 10 and a number of optical fibers 20.

The lens element 10 includes a main body 11 and two covers 12.

The main body 11 is substantially rectangular and includes a front surface 11a, a back surface 11b opposite to the front surface 11a, and a top surface 11c connecting the front surface 11a and the back surface 11b.

The main body 11 defines two positioning recesses 110 in the back surface 11b. Each positioning recess 110 forms an opening 11d in the top surface 11c.

The main body 12 includes four fiber seats 11e, two of which being formed in one positioning recess 110 and the other two of which being formed in the other positioning recess 110. Each fiber seat 11e is configured for seating one of the optical fibers 20 thereon.

The main body 11 includes a number of lenses 111 formed on the front surface 11a and two locating structures 112 formed in/on the front surface 11a. The lenses 111 and the locating structures 112 are arranged substantially in a line. The locating structures 112 are positioned at opposite sides of the lenses 111. The locating structures 112 in this embodiment are locating holes but can be locating poles in another embodiment.

In assembly, optical fibers 20, in twos, are inserted into one of the positioning recesses 110. Each optical fiber 20 seats on one of the fiber seats 11e and points to one of the lenses 111. Each cover 12 is pressed into an opening 11d to seal the opening 11d. The optical fibers 20 are pressed by the covers 12 and thus are fixed in place.

A method for detecting any misalignment between an optical fiber 20 and a lens 111 includes the following steps S1-S8:

In step S1, light is directed into the optical fibers 20 such that each optical fiber 20 emits light to form a light spot 20a on the front surface 11a. This step is achieved by coupling a light source (not shown) to an end of the optical fibers 20 away from the lens element 10.

In step S2, an image of the front surface 11b is captured. This step is achieved by a camera module (not shown).

In step S3, a coordinate system “oxy” is established in image. This step can be by any available image processing device. In this embodiment, the locating structures 112 are recognized and centers A, A′ of the locating structures 112 are found. A connection line passing through the center A, A′ is drawn and this line functions as the x axis of the coordinate system oxy. A middle point of the centers A, A′ is found and this point functions as the origin “o” of the coordinate system oxy. A line passing through the origin “o” and perpendicular to the x axis is drawn and functions as the y axis of the coordinate system oxy. Thus, the coordinate system oxy is established. The coordinate system oxy is not limited to this embodiment but can be changed according to need.

In step S4, coordinate values of centers of the lenses 111 and of the light spots 20a in the coordinate system oxy are measured. This step can also be carried out by the suitable image processing device. In particular, the lenses 111 and the light spots 20a are recognized and then the coordinate values are calculated.

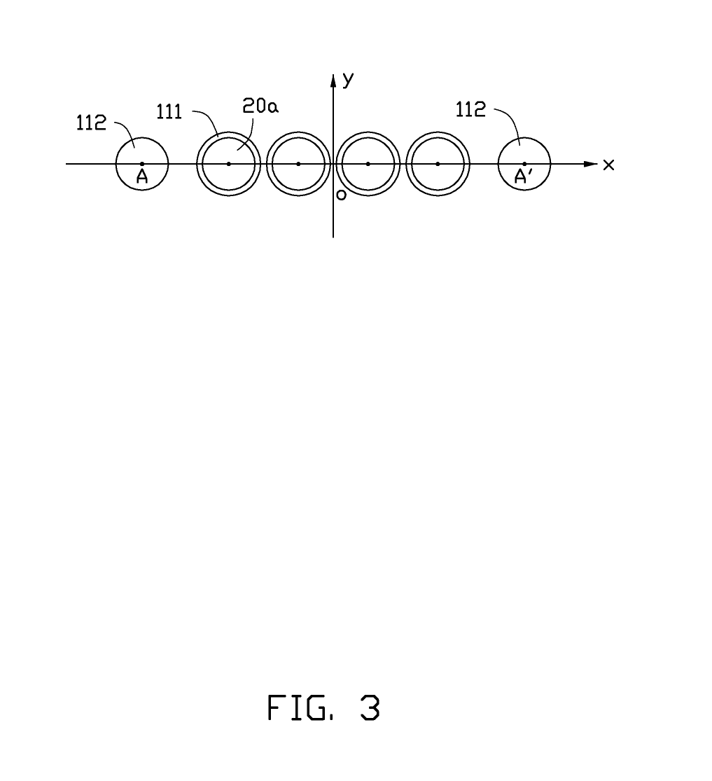

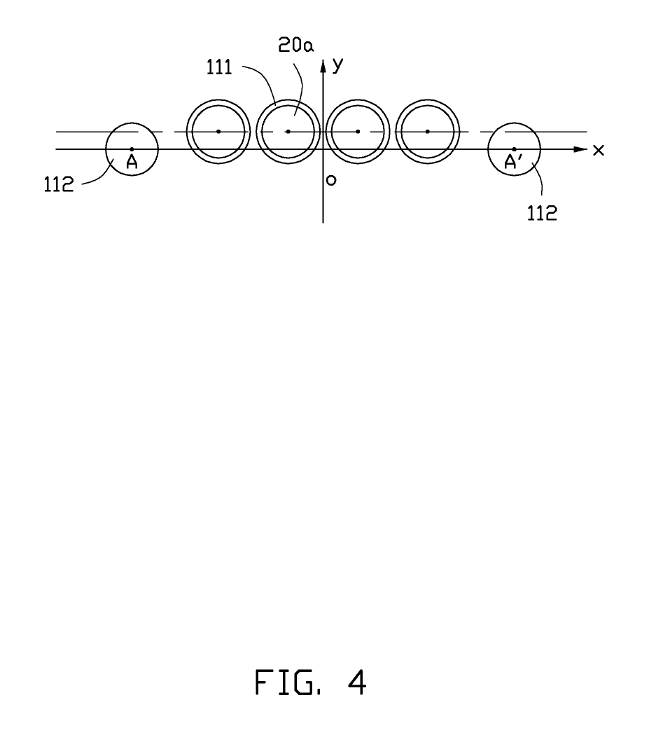

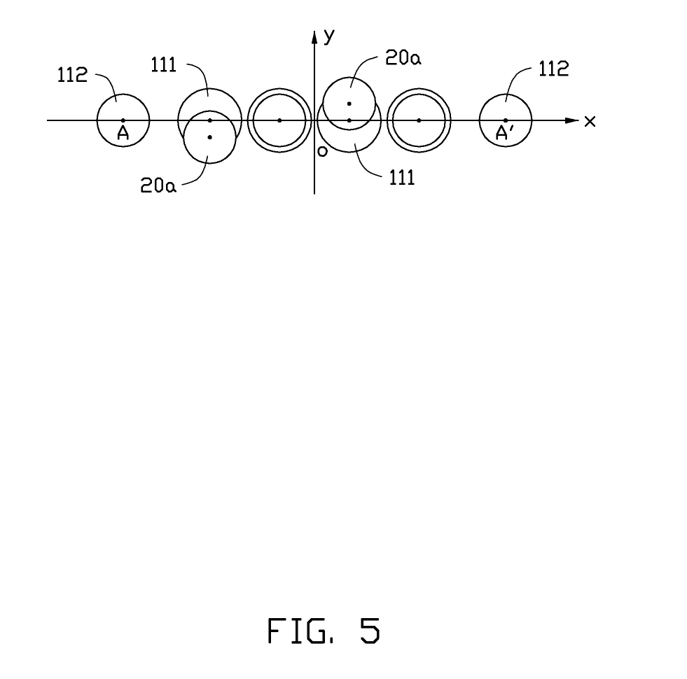

In step S5, the coordinate values of the center of each lens 111 are compared for matching the coordinate values of the center of the superimposed light spot 20a or otherwise. If yes, the lens 111 is thus aligned with the optical fiber 20, but if no, the lens is deemed misaligned with the optical fiber 20. This can also be carried out by the image processing device. For example, FIG. 3 shows that all of the centers of the lenses 111 and the light spots 20a fall in the x axis and that each lens 111 is coaxial with the corresponding spot 20a (that is, the lens 111 is aligned with the optical fiber 20). FIG. 4 shows that each lens 111 is coaxial with the corresponding light spot 20a though all of the centers of the lenses 111 and that the light spots 20a deviate from the x axis. FIG. 5 shows that all of the centers of the lenses 111 and that two of the light spots 20a fall in the x axis, but that the centers of the other light spots 20a deviate from the x axis; two of the lenses 111 are coaxial with light spots 20a while the other two lenses 111 are not coaxial with the corresponding light spots 20a (that is, two of the lenses 111 are misaligned with their corresponding optical fibers 20).

Numbers of the optical fibers 20 and the lenses 111 can be changed depending on need. For example, in another embodiment, only one optical fiber 20 and one lens 111 can be employed. Correspondingly, numbers of the recesses 110 and the seats 11e should be changed as needed.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A method comprising:
directing light into an optical fiber of an optical connector, the optical connector comprising a lens element having a front surface forming a lens and a back surface defining a recess, the optical fiber being inserted into the recess and pointing to the lens, the light forming a light spot on the front surface;
capturing an image of the front surface;
establishing a coordinate system in the image;
measuring coordinate values of centers of the lens and the light spot in the coordinate system; and
determining if the coordinate values of the center of the lens are identical to the coordinate values of the center of the light spot;
wherein the optical fiber is aligned with the lens when the coordinate values of the center of the lens are identical to the coordinate values of the center of the light spot, and the optical fiber is misaligned with the lens when the coordinate values of the center of the lens are not identical to the coordinate values of the center of the light spot.

2. The method of claim 1, wherein the lens element comprises a main body and a cover, the main body has the front surface, the back surface, and a top surface connecting the front surface and the back surface, the recess forms an opening in the top surface, and the cover seals the opening.

3. The method of claim 2, wherein the main body further comprises a fiber seat, the fiber seat is formed in the recess and for seating the optical fiber, and the cover presses the optical fiber on the fiber seat.

4. The method of claim 1, wherein the lens element comprises two locating structures on the front surface, the locating structures and the lens are arranged in a line, the coordinate system is established by:
recognizing the locating structures;
finding centers of the recognized locating structures;
taking a connection line passing through the centers of the recognized locating structures as the x axis of the coordinate system;
taking a middle point of the connection line between the centers of the recognized locating structures as the origin of the coordinate system; and
drawing a line passing through the origin and perpendicular to the x axis as the y axis of the coordinate system.
